(19) United States
(12) Patent Application Publication
(10) Pub. No.: US 2019/0386449 A1
(43) Pub. Date: Dec. 19, 2019

(54) Composite Laser for Producing Multiple Temporal Ignition Pulses

(71) Applicant: United States Department of Energy, Washington, DC (US)

(72) Inventors: Dustin L. McIntyre, Washington, PA (US); Steven D. Woodruff, Morgantown, WV (US); Jinesh C. Jain, South Park, PA (US)

(21) Appl. No.: 16/011,846

(22) Filed: Jun. 19, 2018

(51) Int. Cl. H01S 3/11; H01S 3/0941; H01S 3/094; G01J 3/443; F02C 7/264

(52) U.S. Cl. CPC H01S 3/11; H01S 3/0941; H01S 3/0612; G01J 3/443; F02C 7/264; H01S 3/094038

(57) ABSTRACT

Materials, method of making and methods of using a composite laser for producing multiple temporal ignition pulses. The composite laser includes a pump source forming an optical path in an active media in a cavity of the laser; and a Q-switched material located in a center of a rod in communication with the active media and blocking a portion of the active media.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

One or more embodiments consistent with the present disclosure relate to composite lasers. More specifically, one or more embodiments consistent with the present disclosure related to composite lasers for producing multiple temporal ignition pulses.

### BACKGROUND

The disclosure provides a system and method for Laser-induced breakdown spectroscopy (LIBS) and/or Laser ignition.

One or more advantages of embodiments of the invented concept enable improved plasma maintenance and lifetime that may improve ignition of combustible air/fuel mixtures. The improved plasma maintenance and lifetime may also provide more light and an improved signal-to-noise (SNR) for LIBS measurements.

The efficient operation of natural gas fueled engines is essential for reducing transportation and energy costs, fuel consumption and harmful emissions. When operating a natural gas fueled engine in the lean-burn regime misfire may be a limiting factor. The lean operation of the engine may significantly reduce the production of NOx. However incomplete mixing and/or combustion may lead to unnecessary misfire when the ignition spark occurs and fails to ignite the mixture properly or not at all due to local mix heterogeneity. Every engine has a slightly different intake and fuel introduction design so that manufacturers tend to keep lean operation closer to stoichiometry to stay away from the lean limit, avoiding misfires. Also, variability in the composition and/or the BTU value of the natural gas may cause issues with ignitability when at or near the lean limit of operation. Embodiments address the extension of the lean operation envelope by causing a single laser to produce two different types of output pulses that are then focused into the combustion chamber thereby providing a longer lasting spark plasma that significantly increases the chance of initiating proper ignition for lean operation.

These and other objects, aspects, and advantages of the present disclosure will become better understood with reference to the accompanying description and claims.

### SUMMARY

Embodiments of the invention relate to combining the operation of a pulsed ignition inducing laser with that of a continuous wave (CW) or sustaining laser. The initiation of the spark and the subsequent pumping or maintenance of the spark performed by the same, monolithic, diode pumped, passively Q-switched laser is unique.

One embodiment relates to a composite laser for producing multiple temporal ignition pulses. The composite laser includes a pump source forming an optical path in an active media in a cavity of the laser; and a Q-switched material located in a center of a rod in communication with the active media and blocking a portion of the active media.

Another embodiment relates to a composite laser for producing multiple temporal ignition pulses. The composite laser includes a laser housing having proximal and distal ends defining a cavity and containing an active media; a pump source in optical communication with the proximal end and forming an optical path in the active media; and a Q-switched material in communication with the active media that blocks a portion of the active material such that a size of a pulse of the Q-switched laser may be dictated by a diameter of the Q-switched material.

Another embodiment relates to a composite laser for producing multiple temporal ignition pulses. The composite laser includes a laser housing having proximal and distal ends defining an optical cavity and containing an active media; a pump light source in optical communication with the proximal end and forming a pump light envelope through the active media; a first area of the optical cavity blocked by a Q-switched material; a second area of the optical cavity containing an un-doped material; and an optical coupler proximate the distal end and in optical communication with at least the first area of the optical cavity

The following U.S. patent applications are incorporated herein by reference in their entirety:

1. U.S. Pat. No. 7,149,231 to Afzal et al. discloses a monolithic side pumped composite laser for producing single Q-switched laser pulse;

2. U.S. Pat. No. 4,682,335 to Hughes discloses a composite laser oscillator producing a single laser output, meant to eliminate the need for AR coatings and special mounts for Brewster angle surfaces;

3. U.S. Pat. No. 7,158,546 to Kouta et al. discloses a composite laser rod, with a doped rod inserted into an undoped cylinder, improving thermal rejection;

4. U.S. Pat. No. 7,496,125 to Kouta et al. discloses a composite laser rod, with a doped rod inserted into an undoped cylinder, improving thermal rejection;

5. U.S. Pat. No. 7,960,191 to Ikesue discloses a method of producing a composite laser rod that is surrounded by an undoped portion for heat removal;

6. U.S. Pat. No. 5,756,924 to Early disclose a modification of electro-optical Q-switch producing multiple pulses, also using multiple lasers to produce a high peak power pulse to initiate a spark and a lower peak power pulse to sustain the spark;

7. U.S. Pat. No. 6,382,957 to Early et al. disclose a split CW pulse into two, pump high peak power lasers producing a pulse with first portion, then uses a second CW pulse to pump the spark in addition to describing an optical switch;

8. U.S. Pat. No. 6,394,788 to Early et al. disclose a CW pulse split into two, pump high peak power lasers producing a pulse with first portion, then uses the second CW pulse to pump the spark in addition to an optical switch;

9. U.S. Pat. No. 6,413,077 To Early et al. discloses a CW split pulse into two, pump high peak power lasers producing a pulse with first portion, then uses the second CW pulse to pump the spark in addition to an optical switch;

10. U.S. Pat. No. 6,428,307 to Early et al. discloses a CW pulse split into two, pump high peak power lasers producing a pulse with first portion, then uses the second CW pulse to pump the spark in addition to an optical switch;

11. U.S. Pat. No. 6,514,069 to Early et al. discloses a CW pulse split into two, pump high peak power lasers to produce a pulse with first portion, then use second CW pulse to pump the spark in addition to an optical switch;

12. U.S. Pat. No. 6,676,402 to Early et al discloses using polarization to separate then recombine long pulses. Split CW pulse into two, pump high peak power laser to produce a pulse with first portion, then use second CW pulse to pump the spark and optical switch;

13. U.S. Pat. No. 9,297,696 to Woodruff et al. discloses a laser based Analysis using a Passively Q-Switched Laser including an optically pumping source optically connected to a laser media.

### BRIEF DESCRIPTION OF THE DRAWINGS

These and other features, aspects, and advantages of the multiple embodiments of the present invention will become better understood with reference to the following description, appended claims, and accompanied drawings where:

FIG. 1 depicts a schematic of a composite monolithic continuous wave/Q-switched (CW/QSW) laser in accordance with one embodiment;

FIG. 2 depicts the time evolution of the input pumping and output pulses of the composite monolithic CW/QSW laser of FIG. 1;

FIG. 3 depicts a schematic of a composite monolithic CW/QSW laser in accordance with another embodiment;

FIG. 4 depicts a cross section of the pumped active media of the composite monolithic CW/QSW laser of FIG. 3;

FIG. 5 depicts the cause and effect relationship between varying CW pump and PQSW output;

FIGS. 6A-6D depict graphs illustrating atomic emission spectra (Strontium and Aluminum) for single laser LIBS and enhance LIBS using a CW laser applied at different times with respect to the YAG laser pulse;

FIG. 7 depicts a graph illustrating Sr 407 nm Peak intensity decay for regular (blue) and enhanced (red) LIBS vs. time (microseconds);

FIG. 8 depicts a graph illustrating Sr 421 nm Peak intensity decay for regular (blue) and enhanced (red) LIBS vs. time (microseconds);

FIG. 9 depicts a graph illustrating 394 nm Peak intensity decay for regular (blue) and enhanced (red) LIBS vs. time (microseconds);

FIG. 10 depicts a graph illustrating Al 396 nm Peak intensity decay for regular (blue) and enhanced (red) LIBS vs. time (microseconds);

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide description of composite monolithic CW/QSW lasers, methods of their preparation, and methods for using such composite monolithic CW/QSW lasers.

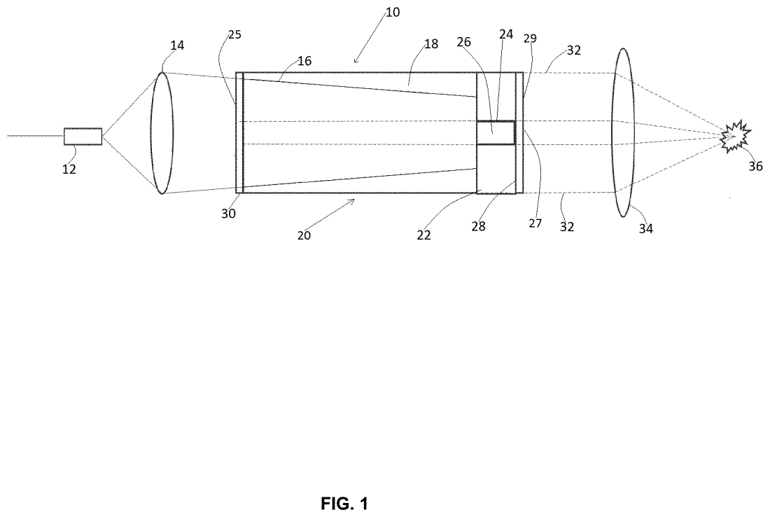

FIG. 1 depicts a schematic of a composite monolithic CW/QSW laser 10 in accordance with one embodiment. One or more embodiments relate to the construction of a diode pumped solid state laser 10 that produces both CW (low peak power) and high energy (high peak power) Q-switched output pulses. The construction of the laser 10 involves a pump source coupling 12 in optical communication with a lens 14, a collecting and refocusing lens for example, forming an optical path or pump light envelope 16 in or directed through the active media 18 in the laser or optical cavity 20.

FIG. 1 further illustrates the laser 10 includes an end pumped laser gain material 18 is larger in diameter than what would typically be needed for a passively Q-switched laser system. In at least one embodiment, the end pumped laser gain material is the active media of the laser (Nd Doped YAG media for example). The embodiment illustrated in FIG. 1 includes a high reflection coating for the laser wavelength combined with an anti-reflection coating for the pumping energy wavelength, general designated 25; and a passive Q-switch 26 in the center of the pumped active media 18 at the end 28 distal from the proximal or pumped end 30. The output coupler for each section of the laser is constructed by two partial reflectivity coating layers, one coating 27 over the central section blocked by the Q-switch material 26 and the balance of the coating 29 over the annular section of the undoped YAG material 22, positioned at end 28. Placing the passive Q-switch 26 in the center of the pulsed area 24 distal from the pumped end 30 blocks the central area 24 of the laser cavity, enables the size of the Q-switched pulse 26 to be dictated by the diameter of the Q-switch material. In at least one embodiment, coatings 27 and 29 form a composite output coupler, where the output coupler coating 27 is on the Q-switched material while the output coupler coating 29, which is on a different composition/value from the output coupler coating 27, and covers the Q-switch material.

The pumping energy is exposed not only to the area 24 blocked by the Q-switch 26, is directed to the unblocked portion of the laser gain material 18 as illustrated in FIG. 1. The Q-switch 26 prevents laser oscillation within the central portion of the laser media 18 until the Q-switch 26 is saturated. However, the annular section of the undoped YAG material 22 that is not blocked by the Q-switch 26 produces CW output as soon as the lasing threshold is met. FIG. 1 further depicts the laser 10 generates a plurality of optical paths or laser output beam path envelope 32. The paths or envelope 32 impinge on the window lens 34 forming a spark or laser induced plasma 36.

In at least one embodiment the output coupler (OC) of the laser 10 has two different reflectivities, one reflectivity for the coating 27 on the Q-switched portion and one reflectivity for the coating 29 on the CW portion. In order to optimize the output parameters for the task at hand requires drastically different OC reflectivity values. One OC could be vapor deposited onto the free end of the Q-switch 26 and the other OC could be vapor deposited onto the face of the undoped YAG material 22, except for that portion blocked by the Q-switch 26.

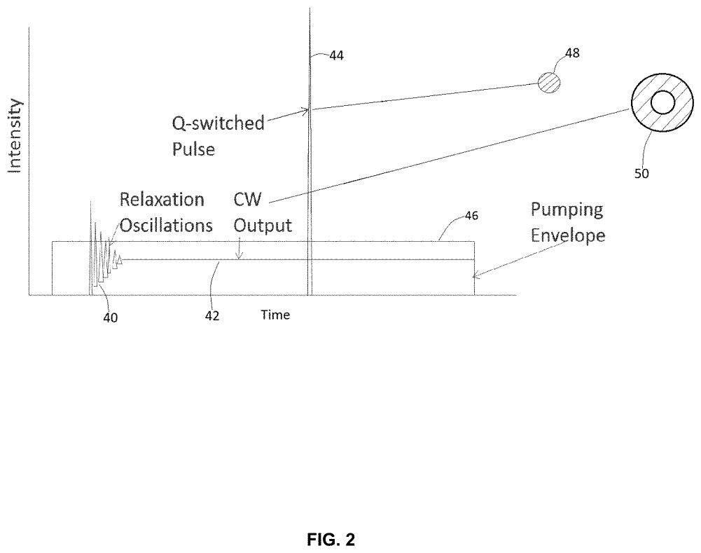

One or more embodiments may include an output coupler created on a single substrate by depositing a central portion and an annular portion separately. An output coupler may also be formed by depositing a first film across the entire substrate and then either depositing additional material over either the central spot or the annular area. The resulting laser 10 produces a donut shaped output beam in the CW regime and a centrally located high peak power Q-switch pulse (See FIG. 2). The combination of the two acts to pre-warm then ignite a solid, liquid, or gas. The continued application of the CW pulse after the production of the Q-switched pulse acts to pump and/or maintain a plasma discharge for a significant amount of time.

One or more embodiments may be modified to produce multiple output pulses as well as CW maintaining pulses in addition to additional Q-switched pulses of varying output energy, pulse width, delay, and repetition frequency.

FIG. 2 depicts a graph illustrating the time evolution of the input pumping and output pulses of the CW laser of FIG. 1. FIG. 2 depicts the pumping envelope 46 which illustrates when the pump system is turned on and delivers pumping energy (at 808 nm in one exemplary embodiment). FIG. 2 further depicts the CW laser warming up 40, alternatively referred to as the CW relaxation oscillations, until it reaches a steady state CW laser output as a function of time 42. The beam shape at the steady output 42 is doughnut shaped and designated 50. After a delay, the central section of the laser is triggered and produces a passively Q-switched output 44. The beam shape at the Q-switched pulse is round and designated 48.

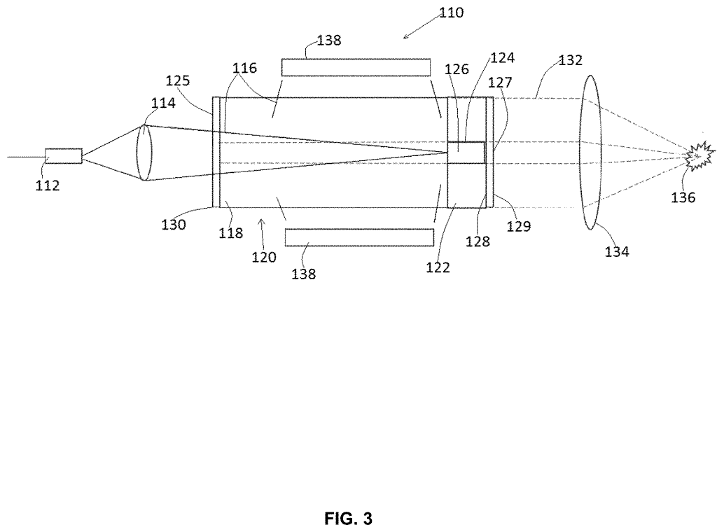

FIG. 3 depicts a schematic of a monolithic composite laser system 110 in accordance with one embodiment. One or more embodiments relate to the construction of a diode pumped solid state laser system 110 that produces both CW (low peak power) and high energy (high peak power) Q-switched output pulses. The construction of the laser 110 involves a pump source comprised of pumping energy directed through a coupling 112 in optical communication with a lens 114, a collection and refocusing lens or lens system for example, and one or more additional laser diode pumps or sources 138 adding energy from the side of the laser media, forming optical path 116 in the active media 118 (Nd doped YAG material for example) in the laser cavity 120. In at least one embodiment, the laser diode pumps or sources 138 are positioned between proximal and distal ends of the laser 110 at an angle (90 degrees for example) to the optical path 116.

FIG. 3 further illustrates the laser 110 includes the active gain material 118 that is larger in diameter than what would typically be needed for a passively Q-switched laser system. The embodiment illustrated in FIG. 3 includes a passive Q-switch 126 in the central area of the rod 124 at the end 128 distal from the pumped end 130 blocking the Q-switched material. Two separate coating layers 127 and 129 act as the output coupler (OC) for the laser systems and are positioned at end 128. Placing the passive Q-switch 126 in the pumped area 124 at distal from the pumped end 130, enables the size of the Q-switched 126 to be dictated by the diameter of the Q-switch material.

The pumping energy is exposed not only to the inner portion of the laser cavity 120 that is blocked by the Q-switch 126. It is directed to the unblocked portion of the laser gain material 118 as illustrated in FIG. 3. The Q-switch 126 prevents laser oscillation within the central portion of the laser media 118 until the Q-switch 126 is saturated. However the annular section of the gain medium 118 that is not blocked by the Q-switch 126 produces CW output as soon as the lasing threshold is met. FIG. 3 further depicts the laser 110 generates a plurality of optical paths 132. The optical paths 132 impinge on the window lens 134 forming a spark 136.

The distal end 128 of the laser 110 has two different reflective coatings, one for the Q-switched portion 127 and one for the CW portion 129. In order to optimize the output parameters for the task at hand requires drastically different OC reflectivity values. One OC could be vapor deposited onto the free end of the Q-switch 126 and the other OC could be vapor deposited onto the face of the gain material 118, except for that portion blocked by the Q-switch 126.

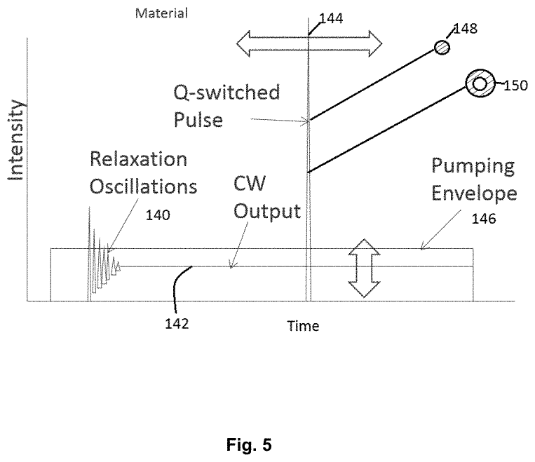

One or more embodiments may include an OC created on a single substrate by depositing a central portion and an annular portion separately. An output coupler may also be made by depositing a first film across the entire substrate and then either depositing additional material over either the central spot or the annular area. The resulting laser 110 produces a donut shaped output beam in the CW regime and a centrally located high peak power Q-switch pulse (See FIG. 5). The combination of the two beams acts to pre-warm then ignite a solid, liquid, or gas. The continued application of the CW pulse after the production of the Q-switched pulse acts to pump and/or maintain a plasma discharge for a significant amount of time.

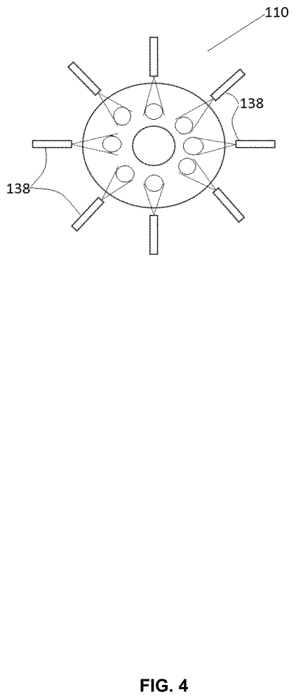

FIG. 4 depicts a cross section of the pumped active media of the laser 110 of FIG. 3. FIG. 4 depicts the plurality of additional laser diode pumps or pumping source 138 adding energy from the side of the laser media, delivering laser pump energy through the side of the laser rod 118. In at least one embodiment, the laser diode pumps or sources 138 are positioned at an angle (90 degrees for example) to the optical path 116.

FIG. 5 depicts a graph illustrating the time evolution of the input pumping and output pulses of the CW laser of FIG. 3. FIG. 5 depicts the pumping envelope 146 which illustrates the pump system turned on and delivering laser pulses. FIG. 5 further depicts the CW laser warming up 140, alternatively referred to as the CW relaxation oscillations, until it reaches a steady state CW laser output 142 pulsed output from the Q-switched portion of the laser as a function of time designated 142. The cross-section of the Q-switch output beam shape at the steady output 142 is doughnut shaped and designated 150. After a delay Q-switched pulse is generated designated 144. The cross-section of the beam shape at the Q-switched pulse is round and designated 148.

Embodiments may be used as an ignition source for solids, liquids, and/or gases. One or more embodiments may be used as a plasma excitation source for LIBS.

Embodiments may also be used as a LIBS excitation laser system. By initiating and then maintaining a plasma for an extended period of time this excitation source could improve the SNR of a LIBS system. This system could also be used for a combination laser ignition/LIBS system.

Experiments were performed where a nanosecond pulsed laser was used to initiate a plasma and then a CW laser was used to ‘pump’ or enhance both the overall emission and lifetime of the plasma. The process of pumping the plasma is a relatively simple technique and can provide significant enhancement of the signals.

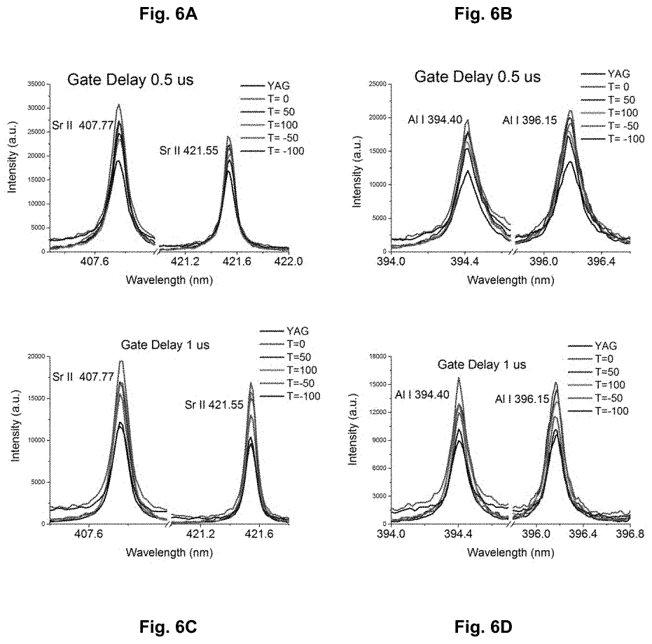

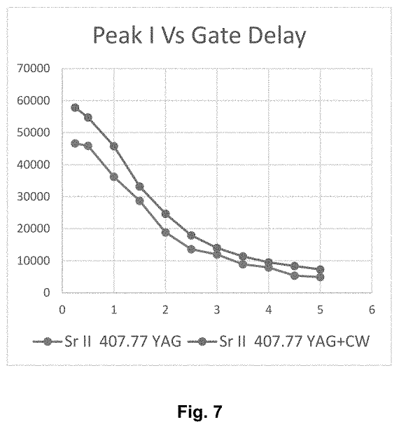

The spectra illustrated in FIGS. 6A-6D depict the baseline LIBS data (YAG) in black and are the smallest height. For all of the plots the baseline represents the lowest amount of atomic emission of the labeled Strontium (Sr) and Aluminum (Al) lines. The other spectral signatures represent the application of a secondary continuous wave laser pulse either before (T=−50, T=−100), during (T=0), or after (T=50, T=100) the initial LIBS plasma production by the YAG laser [All time values for this plot are in microseconds]. There is a clear enhancement of the atomic emission by the use of a secondary CW laser excitation. The optimal timing between the two laser pulses is shown on each plot as approximately T=−50. T=−50 indicates the scenario where the CW laser is applied 50 microseconds prior to the arrival of the YAG pulse that creates the LIBS plasma. The CW laser acts to both preheat the sample and heat the plasma throughout its lifetime in a way that enhances the atomic emission. The two rows of spectra in FIG. 7 include a textbook example representing a delay in the data acquisition with the gated spectrometer. When the plasma is created the initial thermoluminescence and incandescence of the hot plasma produces a broad continuum emission that has no useful information. Therefore the spectrometer data acquisition is delayed 300-500 nanoseconds to allow the plasma to cool and begin the process of electron recombination where the atomic emission is produced.

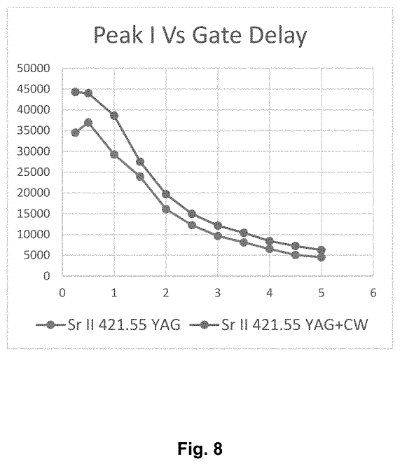

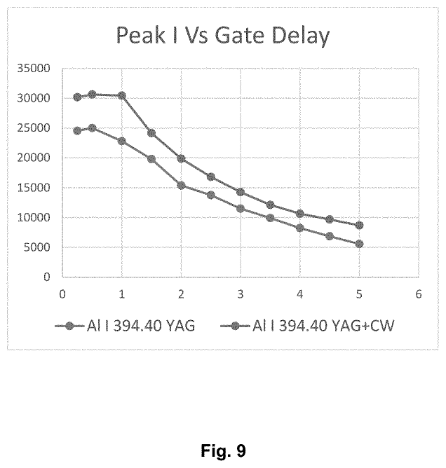

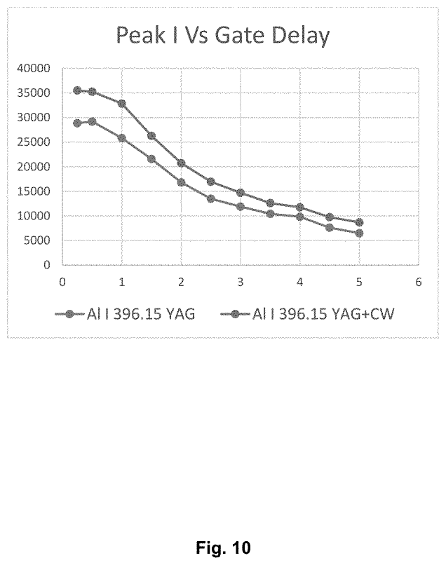

FIGS. 7-10 illustrate decay curves of the atomic emission lines of two Strontium lines and two Aluminum lines when produced by the YAG laser alone (blue) and with the CW laser enhancement (red). The data illustrates that the application of the CW laser produces an upward shift in the data. This indicates that the plasma remains hotter for longer thereby producing more light over a longer period of time. This additional light will act to improve the signal to noise ratio of any quantitative measurement of the elemental concentrations. The goal of the laser design is the consolidation of the two laser systems into one miniature monolithic crystal that can produce coaxial laser beams that can be easily focused to the same sample point. The data presented is in no way optimized geometrically to maximize laser interaction volumes or data collection efficiency.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. A composite laser for producing multiple temporal ignition pulses, the composite laser comprising:
a pump source forming an optical path in an active media in a cavity of the laser; and
a Q-switched material located in a center of a rod in communication with the active media and blocking a portion of the active media.

2. The composite laser of claim 1 further comprising a Q-switched portion having a first reflectivity.

3. The composite laser of claim 2 further comprising a continuous wave (CW) portion having a second reflectivity.

4. The composite laser of claim 3 further comprising an output coupler.

5. The composite laser of claim 4 wherein the output coupler is formed on a single substrate and includes a central portion and an annular portion.

6. The composite laser of claim 1 further comprising a highly reflective coating for a laser wavelength on a first portion combined with an anti-reflective coating for a pumping energy wavelength on a second portion different from the first portion.

7. The composite laser of claim 1 wherein the pump source comprises a coupling in optical communication with a lens.

8. The composite laser of claim 7 wherein the pump source further comprises one or more laser diode sources positioned at an angle to the optical path.

9. A composite laser for producing multiple temporal ignition pulses, the composite laser comprising:
a laser housing having proximal and distal ends defining a cavity containing an active media;
a pump source in optical communication with the proximal end and forming an optical path in the active media; and
a Q-switched material in communication with the active media that blocks a portion of the active material such that a size of a pulse of the Q-switched laser may be dictated by a diameter of the Q-switched material, further comprising a Q-switched portion having a first reflectivity and a Continuous Wave (CW) portion having a second reflectivity.

10. (canceled)

11. (canceled)

12. The composite laser of claim 9 further comprising an output coupler.

13. The composite laser of claim 12 wherein the output coupler is formed on a single substrate and includes a central portion and an annular portion.

14. The composite laser of claim 9 further comprising a highly reflective coating for a laser wavelength combined with an anti-reflective coating for a pumping energy wavelength.

15. The composite laser of claim 9 wherein the pump light source comprises a coupling in optical communication with a lens positioned proximate the proximal end.

16. The composite laser of claim 15 wherein the pump light source further comprises one or more laser diode sources positioned at an angle to the optical path.

17. A composite laser for producing multiple temporal ignition pulses, the laser comprising:
a laser housing having proximal and distal ends defining an optical cavity containing an active media;
a pump light source in optical communication with the proximal end and forming a pump light envelope through the active media;
a first area of the optical cavity blocked by a Q-switched material;
a second area of the optical cavity containing an un-doped material; and
an optical coupler proximate the distal end and in optical communication with at least the first area of the optical cavity, comprising a highly reflective coating for a laser wavelength combined with a separate anti-reflective coating for a pumping energy wavelength.

18. The composite laser of claim 17 wherein the optical coupler comprises a first output coupler coating and a second output coupler coating having a different composition value than the first output coupler coating.

19. The composite laser of claim 18 further comprising the first output coupler coating contacting the first area of the optical cavity blocked by the Q-material.

20. The composite laser of claim 19 further comprising the second output coupler contacting the second area of the optical cavity containing the un-doped material.

21. (canceled)

22. The composite laser of claim 20 further comprising first and second lenses.

23. The composite laser of claim 22 wherein the first lens comprises a collection and focusing lens proximate to the proximate end,

24. The composite laser of claim 22 wherein the second lens comprises an output focusing optic proximate the distal end.

25. The composite laser of claim 22 wherein the pump light source comprises a coupling in optical communication with the first lens.

26. The composite laser of claim 25 wherein the pump light source further comprises one or more laser diode sources positioned between the proximal and distal ends and at an angle to the pump light envelope.
